(19) United States
(12) Patent Application Publication
(10) Pub. No.: US 2016/0134842 A1
(43) Pub. Date: May 12, 2016

(54) MOBILE DEVICE CAPABLE OF BEING ASSOCIATED WITH SECURITY EQUIPMENT USING WIDGET

(71) Applicant: IDIS CO., LTD., Daejeon-si (KR)

(72) Inventors: Young Seo CHA, Seongnam-si (KR); Sang Ho CHA, Seoul (KR); Sun Min KIM, Wonju-si (KR)

(73) Assignee: IDIS CO., LTD., Daejeon-si (KR)

(21) Appl. No.: 14/609,700

(22) Filed: Jan. 30, 2015

(30) Foreign Application Priority Data
Nov. 6, 2014 (KR) 10-2014-0153859

(51) Int. Cl. H04N 7/18; G08B 13/22

(52) U.S. Cl. CPC H04N 7/18; G08B 13/22

(57) ABSTRACT

Provided is a mobile device including: a storage configured to store a main application associated with a security equipment for a security purpose, and a security widget of the main application; and a controller configured to load the security widget from the storage, wherein the security widget includes: a connection establisher configured to establish connection to the security equipment using connection establishment information that is shared with the main application; and an equipment associator that is configured to comprise a video associator configured to receive a surveillance video frame of a surveillance channel from the connected security equipment and display the received surveillance video frame.

### CROSS-REFERENCE TO RELATED APPLICATION(S)

This application claims priority from Korean Patent Application No. 10-2014-0153859, filed on Nov. 6, 2014, in the Korean Intellectual Property Office, the entire disclosure of which is incorporated herein by reference for all purposes.

### BACKGROUND

1. Field

The following description relates to a mobile device capable of connection with a security system.

2. Description of the Related Art

Korean Patent Publication No. 10-2011-0121056 discloses a Digital Video Recorder (DVR) and vision monitoring method thereof. In this reference, a DVR divides a target area into a plurality of sections and records videos of the sections using a plurality of cameras. In addition, the DVR performs video analytics to track and monitor movement of an object recognized in the target area; manages information on video files of the cameras; and provides the information for searching and playing the video files.

The DVR is aimed at recording a video. Thus, additional procedures or platforms are necessary to check data stored in the DVR.

### SUMMARY

The following description relates to a mobile device capable of being associated with information in a security equipment using a widget.

In one general aspect, there is provided a mobile device including: a storage configured to store a main application associated with a security equipment for a security purpose, and an security widget of the main application; and a controller configured to load the security widget from the storage, wherein the security widget includes: a connection establisher configured to establish connection to the security equipment using connection establishment information that is shared with the main application; and an equipment associator that is configured to comprise a video associator configured to receive a surveillance video frame of a surveillance channel from the connected security equipment and display the received surveillance video frame.

The video associator may be further configured to receive the surveillance video frame from the security equipment at predetermined time intervals or in response to a user's request.

The video associator may be further configured to change an associated surveillance channel into a different surveillance channel in response to a user's manipulation input through a user interface in a case where the security equipment has a plurality of surveillance channels.

The equipment associator may be further configured to comprise an event associator configured to receive a surveillance-related event or a system-related event from the security equipment and display the received surveillance-related event or system-related event on a user interface.

The video associator may be further configured to receive the surveillance video frame from the security equipment at predetermined time intervals or in response to receipt of a user's request, and receive the surveillance frame from the security equipment in real time in a case where an event associated by the event associator is the surveillance-related event.

The video associator is further configured to, in a case where the security equipment has a plurality of surveillance channels and a surveillance channel on which the surveillance-related event has occurred is different from a currently associated surveillance channel, change the currently associated surveillance channel to the surveillance channel on which the surveillance-related event has occurred.

Other features and aspects may be apparent from the following detailed description, the drawings, and the claims.

### BRIEF DESCRIPTION OF THE DRAWINGS

FIG. 1 is a block diagram illustrating a security system according to an exemplary embodiment of the present disclosure.

FIG. 2 is a block diagram illustrating an exemplary embodiment of the present disclosure.

FIG. 3 is a diagram illustrating an idle screen of a security widget in mobile device according to an exemplary embodiment.

FIG. 4 is a block diagram illustrating a security widget according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

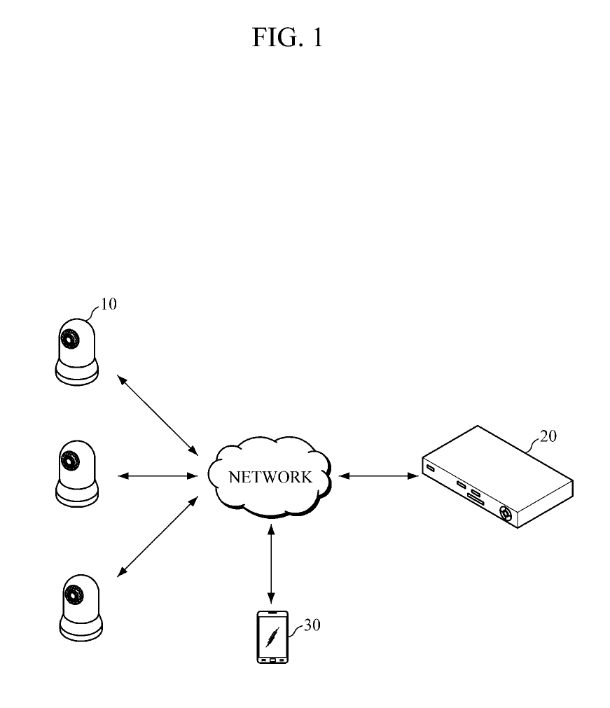

FIG. 1 is a block diagram illustrating a security system according to an exemplary embodiment of the present disclosure. As illustrated in FIG. 1, a security system may include a plurality of surveillance cameras 10, a video recording device 20, and a mobile device 30. Each of the surveillance cameras 10 may be a network camera that monitors a surveillance area and filming a video thereof, and records the video therein or transmits the video to the video recording device 20. The video recording device 20 may be a Digital Video Recorder (DVR), a Network Video Recorder (NVR), or the like. The video recording device 20 may connect a single surveillance camera or may connect a plurality of surveillance cameras in order to have a plurality of surveillance channels. The mobile device 30 may be a smart phone or a smart pad that enables a user to install, add, or delete an application of choice. According to one aspect of the present disclosure, the mobile device 30 connects video and/or event information of a security equipment to a widget. The security equipment may be the video recording device 20, such as a DVR or an NVR, or a surveillance camera 10.

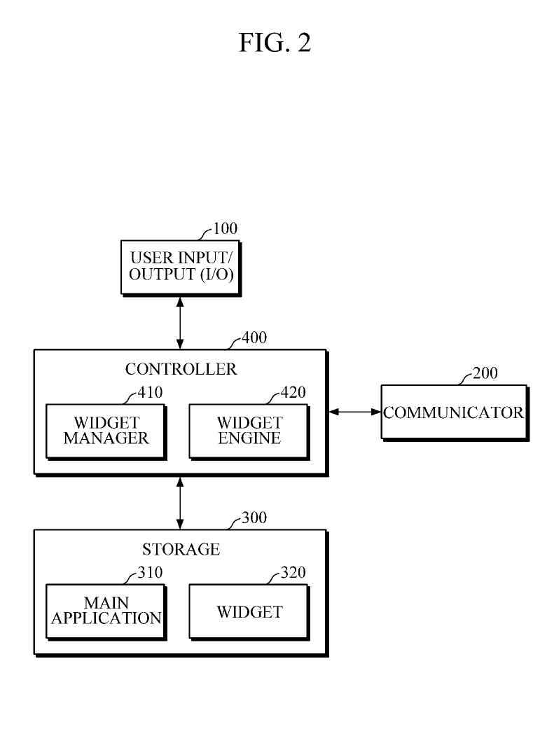

FIG. 2 is a block diagram illustrating an exemplary embodiment of the present disclosure. As illustrated in FIG. 2, a mobile device may include a user input/output (I/O) 100, a communicator 200, a storage 300, and a controller 400. The user I/O 100 may include a display and a touch screen. The display is a component for displaying a resultant image of executing an application and various types of content, such as a widget. The touch screen is provided along with the display to receive a user's input. The communicator 200 may include one or more communication modules for audio/data communication. The storage 300 may be one or more memories that stores a control program and other various kinds of application programs and data. According to one aspect of the present disclosure, the storage 300 may store a main application 310 associated with a security equipment for a security purpose, and a security widget 320 of the main application 310.

The controller 400 may be a control unit that controls overall operations of a mobile device. As illustrated in FIG. 2, the controller 400 may consist of a widget manager 410 and a widget engine 420. The widget manager 410 may add or delete a widget, arrange a widget on an idle screen in response to a user's request, and delete the arranged widget from the idle screen. The widget engine 420 may manage setting information of the widget by receiving the setting information from the widget manager 410. In addition, if a user wants to execute the security widget 320 using the widget manager 410, the widget engine 420 may load the security widget 320 on an idle screen.

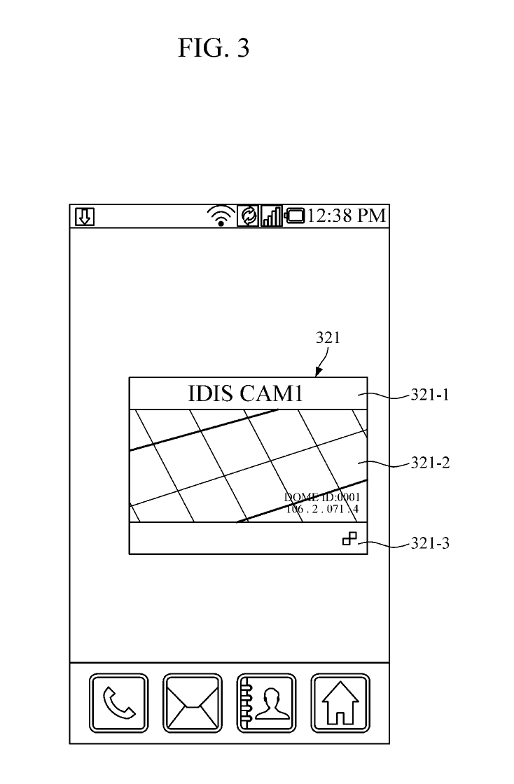

FIG. 3 is a diagram illustrating an idle screen of a mobile device having a security widget set therein according to an exemplary embodiment of the present disclosure. As illustrated in FIG. 3, a graphic user interface 321 of the security widget 320 may be divided into an upper area 321-1, a middle area 321-2, and a lower area 321-3. The upper area 321-1 is an area for displaying surveillance channel information. Once a user clicks the upper area 321-1, changed surveillance information is displayed in the upper area 321-1. For example, in a case where a security equipment has three surveillance channels CAM1, CAM2, and CAM 3, a surveillance channel is changed upon a user's click in a sequence of CAM1→CAM2→CAM3→CAM1. The middle area 321-2 is an area for displaying a monitoring vide of a surveillance channel. Once a user clicks the middle area 321-2, a video frame stored at that same time in a security equipment, that is, a video frame captured at that time, is displayed in the middle area 321-2. The lower area 321-3 is an area for displaying other various kinds of information or receiving a user's input to perform a specific operation. For example, once a user clicks the right side of the lower area 321-3, the main application 310 is called and implemented and, in turn, the security widget 320 associates with the main application 310 to thereby receive a surveillance video from the main application 310 in real time and display the received surveillance video in the lower area 321-3.

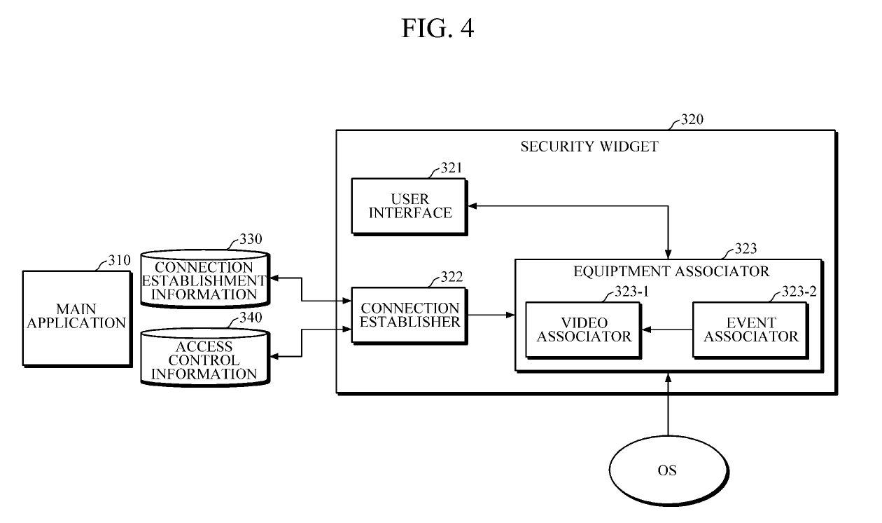

FIG. 4 is a block diagram illustrating a security widget according to an exemplary embodiment of the present disclosure. The security widget 320 may include a connection establisher 322 and an equipment associator 323. The connection establisher 322 establishes connection to a security equipment using connection establishment information 330. The connection establishment information 330 is shared with the main application 310. According to one aspect of the present disclosure, the connection establishment information 330 is shared, regardless of whether the main application 310 is being executed. That is, the connection establishment information 330 is managed to be shared by the security widget 320 regardless of whether the main application 310 is being executed. In addition, regardless of the security widget 320 is being executed, the main application 310 may remain in a sleep mode as long as a user does not input a specific execution command.

The equipment associator 323 is associated with a security equipment connected by the connection establisher 322. The equipment associator 323 may be associated with the video recording device 20 or a surveillance camera 30 depending on a user's selection. As illustrated in FIG. 4, the equipment associator 323 may include a video associator 323-1. The video associator 323-1 receives a video frame of a surveillance channel from a security equipment, and outputs the received video frame to the user interface 321. Accordingly, a surveillance video frame is displayed in the middle area 321-2 on the user interface 321.

According to one aspect of the present disclosure, the video associator 323-1 may receive a surveillance video frame of a surveillance channel from a security equipment at predetermined time intervals or in response to a user's request. For example, the video associator 323-1 may request a surveillance video frame of a surveillance channel from a security equipment at predetermined time intervals, such as every one minute, every five minutes, or every ten minutes. Alternatively, if a user's request is received, the video associator 323-1 may request and receive, from a security equipment, a surveillance video frame captured at when the user's request is received. For example, a user may click the middle area 321-2 of the security widget 320, illustrated in FIG. 2, to thereby receive a surveillance video frame captured at a time when the click is made. Receiving a video frame at predetermined time intervals or in response to a user's request is aimed to reduce the load on a mobile device.

Meanwhile, if the security equipment is a DVR or an NVR, there may be a plurality of surveillance channels. If the security widget 320 associates with an DVR or NVR which has a plurality of surveillance channels, the video associator 323-1 may change from a currently associated surveillance channel to a different one in response to a user's manipulation. Referring to FIG. 2, the security widget 320 is currently associated with the surveillance channel CAM 1, as shown in the upper area 321-1 of the security widget 320. Once a user clicks the upper area 321-1, the video associator 323-1 changes from the surveillance channel CAM 1 to the surveillance channel CAM 2, and notifies the security equipment of the change. Then, the security equipment transmits a surveillance video of the surveillance CAM to the security widget 320.

According to one aspect of the present disclosure, the equipment associator 323 may further include an event associator 323-2. The event associator 323-2 receives event information from the security equipment, and outputs the received event information to the user interface 321. The event information may be displayed either on the middle area 321-2 or the lower area 321-3 of the user interface 321. An event may be a surveillance-related event or a system-related event. The surveillance-related event may include a motion event that indicates a detection of a personal movement or intrusion. The system-related event is an event regarding a system of the security equipment; specifically, it may be about a system state, such as video loss or disk full.

According to an exemplary embodiment, the event associator 323-2 requests and receives, from the security equipment, event occurrence information. Thus, a user is able to receive event information, especially system-related event information, at a desired point in time. According to another exemplary embodiment, the event associator 323-2 receives event information in a push message from the security equipment. For example, an operation system (OS) of the mobile device 30 may process a push message in the background, and the security widget 320 may receive event information, which has been processed in the background, through service communication in a form of local socket and display the received event information on the user interface 321. The event information may be an alarm notification that notifies occurrence of an event. In this case, the event associator 323-2 may access the security equipment through socket communication to thereby acquire actual event information and display the acquired actual event information on the user interface 321.

According to another aspect, in a case where an event associated by the event associator 323-2 is a surveillance-related event, the video associator 323-1 changes an associated surveillance channel to a surveillance channel on which the surveillance-related event has occurred. For example, if a currently associated surveillance channel is CAM 1 and a surveillance-related event occurs on CAM 3, the video associator 323-1 changes the associated surveillance channel from CAM 1 to CAM 3.

According to yet another aspect, the video associator 323-1 may receive a surveillance video frame of an associated surveillance channel at predetermined time intervals or in response to a user's request; however, if a surveillance-related event occurs, the video associator 323-1 receives a surveillance video frame of the surveillance channel in real time. If a surveillance channel on which the event has occurred is different from a currently associated surveillance channel, the video associator 323-1 changes the currently associated surveillance channel to the surveillance channel on which the event has occurred.

Meanwhile, the security widget 320 may utilize access control information 340. The access control information 340 is information shared with the main application 310 along with the connection establishment information. Specifically, the access control information is information required for setting access authorization for a security equipment or specific information. A pass word may be set for the access authorization. The access control information 340 may be generated by a security equipment and provided to the mobile device 30 along with the main application 310. Alternatively, the access control information 340 may be generated through the main application 310. If there is control setting information, the connection establisher 322 of the security widget 320 may establish connection using the connection establishment information 340 within the scope of authorization cited the access control information 340.

In the case of receiving a video frame in real time and outputting the received video frame to the user interface 321, the video associator 323-1 may receive the video frame from a security equipment in real time, or may receive the video frame from the main application 310 through association with the main application 310. It is because a widget's thread configured to manage a background has sometimes difficulties in processing a real-time streaming data due to a large capacity thereof. As a result, malfunctions, such as halting or power-off of the mobile device 30, may occur. Therefore, for a real-time streaming service, the video associator 323-1 calls the main application 310 to be executed and accordingly receives a video frame from the main application 310 in real time.

As described above, the mobile device 30 is capable of being associated with a video or state information of a security equipment through the security widget 320. In addition, the mobile device 30 is capable of being associated with existing applications through intent communication of Android and Inter-Process Communication (IPC). A mutually associated application may freely access not just information stored in the security widget 320, but also information stored in the main application 310.

According to the above-described embodiments, a mobile device may be able to develop into a kind of security system, compared to conventional security equipment that simply record surveillance videos.

In addition, using a security widget, the mobile device is capable of directly processing a surveillance video or event information in the background.

Further, surveillance videos are received at predetermined time intervals, not in real time, thereby reducing load of the mobile device. Besides, once a surveillance-related event occurs on a surveillance channel, a video of the surveillance channel is provided, thereby enabling a user to monitor the event in real time.

Moreover, surveillance-related event information or information on an event regarding a system of a security equipment may be provided to a user through a security widget.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A mobile device comprising:
a storage configured to store a main application associated with a security equipment for a security purpose and an security widget of the main application; and
a controller configured to load the security widget from the storage,
wherein the security widget comprises:
a connection establisher configured to establish connection to the security equipment using connection establishment information that is shared with the main application; and
an equipment associator that is configured to comprise a video associator configured to receive a surveillance video frame of a surveillance channel from the connected security equipment and display the received surveillance video frame.

2. The mobile device of claim 1, wherein the video associator is further configured to receive the surveillance video frame from the security equipment at predetermined time intervals or in response to a user's request.

3. The mobile device of claim 1, wherein the video associator is further configured to change an associated surveillance channel into a different surveillance channel in response to a user's manipulation input through a user interface in a case where the security equipment has a plurality of surveillance channels.

4. The mobile device of claim 1, wherein the equipment associator is further configured to comprise an event associator configured to receive a surveillance-related event or a system-related event from the security equipment and display the received surveillance-related event or system-related event on a user interface.

5. The mobile device of claim 1, wherein the video associator is further configured to receive the surveillance video frame from the security equipment at predetermined time intervals or in response to receipt of a user's request, and receive the surveillance frame from the security equipment in real time in a case where an event associated by the event associator is the surveillance-related event.

6. The mobile device of claim 5, wherein the video associator is further configured to, in a case where the security equipment has a plurality of surveillance channels and a surveillance channel on which the surveillance-related event has occurred is different from a currently associated surveillance channel, change the currently associated surveillance channel to the surveillance channel on which the surveillance-related event has occurred.
